(19) United States
(12) Patent Application Publication
(10) Pub. No.: US 2026/0094075 A1
(43) Pub. Date: Apr. 2, 2026

(54) SYSTEM AND METHOD FOR DYNAMIC EVENT MANAGEMENT

(71) Applicant: Wells Fargo Bank, N.A., San Francisco, CA (US)

(72) Inventors: Azita Asefi, Vacaville, CA (US); Alan W. Hecht, San Francisco, CA (US); Dennis E. Montenegro, Concord, CA (US); Sadie S. Salim, Mill Valley, CA (US)

(21) Appl. No.: 18/903,873

(22) Filed: Oct. 1, 2024

(51) Int. Cl. G06Q 10/02

(52) U.S. Cl. CPC G06Q 10/025

(57) ABSTRACT

Systems and methods are provided, that include receiving payments, via a payment system, from a plurality of attendees of an event, and tracking an engagement, via one or more sensors, of the plurality of attendees with a plurality of vendors during the event, where the engagement comprises time spent by attendees at each vendor's location of the plurality of vendors. The systems and methods further include allocating the payments, or a portion thereof, via the payment system, to the plurality of vendors in proportion to the tracked engagement of the plurality of attendees with each vendor of the plurality of vendors, and creating a personalized event itinerary for an attendee of the plurality of attendees.

### TECHNICAL FIELD

The present disclosure generally relates to events, and more specifically to dynamic event management.

### BACKGROUND

Event management addresses the organizing and executing various types of gatherings, from street fairs and fundraisers to conferences and trade shows. These event management technologies aim to streamline processes such as attendee registration, scheduling, and vendor coordination. However, the dynamic nature of events presents ongoing challenges in optimizing attendee experiences and managing resource allocation more effectively.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a block diagram of a community-assigned credit score ecosystem, according to some examples.

FIG. 2 is a flowchart of a process for providing dynamic customized event itineraries and event management, according to some examples.

FIG. 3 illustrates machine learning engine for training the one more trained AI models of FIG. 1, including the trained LLMs, according to some examples.

FIG. 4 is a block diagram depicting a machine suitable for executing instructions via one or more processors, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automating the management of events and event attendance, as well as user-level scheduling and tracking. In certain examples, a large language model is used to analyze attendee preferences and create personalized event itineraries. This solves the technical challenge of real-time event optimization by:
Processing large amounts of user preference data efficiently
Generating customized routes through complex event spaces
Adapting recommendations based on changing attendee behavior during the event.

More specifically, the techniques described herein relate to an adaptive event management and engagement system (AEMES) that addresses challenges in improving attendee experiences and vendor compensation at dynamic events such as street fairs, school fundraisers, conferences, and so on. The system incorporates several components and technologies, including artificial intelligence (AI) models, such as large language models (LLMs), to create a more comprehensive system for event management. In some examples, AEMES utilizes a large language model (LLM) to analyze attendee preferences and to create personalized event itineraries. This personalization feature improves attendee enjoyment by focusing on their expressed interests and suggesting specific vendors and a more optimal “route” through the event.

The AEMES additionally provides for the implementation of an upfront fixed cost payment model used for budgeting purposes during an event. In certain examples, attendees can set a budget and/or pay a predetermined amount before starting their event experience, which acts as a consumable budget for purchases at the event. The system tracks the usage of this budget across different vendors, allowing for a more streamlined and cashless experience.

In some examples, vendor compensation is handled through an engagement-based model in addition to or in lieu of traditional payment. The payments made by attendees, or a portion of the payments, are allocated to vendors in proportion to the time attendees spend at each establishment. This pro rata model ensures that vendors are compensated in line with the interest and engagement they generate, rather than solely based on direct purchases. The system dynamically adjusts the distribution of funds to reflect the attendee's actual experience throughout the event.

To address potential issues with long wait times, AEMES includes a compensation mechanism for attendees. The system monitors the time spent waiting at vendors, and if wait times exceed a certain threshold, attendees are awarded credits or given the option to transfer value. This feature aims to maintain a positive attendee experience even in crowded or popular areas of the event.

Additionally, AEMES incorporates an attendee tracking system that can be tailored to the unique vendor lineup of certain events. The system, in some examples, utilizes location tracking on an attendee's smartphone to monitor their movement through the event. This feature enables the facilitation of referral incentives between vendors, such as offering discounts at subsequent booths. For example, Vendor A could refer an attendee to Vendor B, offering the attendee a 15% discount upon arrival, enhancing cross-vendor collaboration and potential savings for attendees. This adaptability allows the system to function across various types of events with different structures and vendor compositions.

In some examples, an inclusivity system is provided as part of AEMES. To promote inclusivity, the inclusivity system considers factors such as income levels and neurodiversity when determining payments for attendees. This feature aims to make events more accessible to a diverse range of participants by potentially adjusting costs based on individual circumstances.

Additionally, AEMES integrates QR code, tokens, or similar functionality with conference invitations or tickets, allowing attendees to register for events using these digital identifiers. The pricing for registration may vary based on the timeline, incentivizing early registration. Engagement with these promotions can lead to rewards such as points or credits, which are redeemable at the event. Once registered, the QR code, token, or similar identifier may be shared with vendors, facilitating a more personalized experience and enabling targeted promotions or interactions.

An advantage of AEMES is its ability to adapt to changing circumstances during the event. If an attendee deviates from their original itinerary, perhaps attracted by an unexpected sight or smell (such as an enticing snack), the system can reallocate resources and adjust recommendations accordingly. This flexibility allows for a more organic and enjoyable event experience while still maintaining the benefits of a structured event with fixed start and stop times for various presentations.

In certain examples, AEMES extends beyond the physical boundaries and timeframe of the event itself. It may continue to track engagement and interactions for a period after the event has concluded. For example, if an attendee later visits a vendor's website, watches videos of a musician they saw perform, or makes additional purchases related to the event, these actions can be factored into the overall engagement metrics and potentially influence vendor compensation. The system's learning capabilities allow it to improve its recommendations and optimizations over time. As it gathers data from multiple events and user interactions, it can refine or tune its models (e.g., AI models) to provide increasingly accurate and personalized suggestions for future events.

For multi-day conferences or larger events, the system can help manage the division and rejoining of groups. For instance, AEMES suggests separate itineraries for couples or friends attending together, allowing them to explore different areas of interest before reconvening at specified times or locations. The social networking aspect of the AEMES enables attendees to connect with friends or colleagues who are also present at the event. The system can notify users of the presence of their contacts and suggest meeting points or shared activities based on mutual interests and event schedules.

While the primary focus is on physical events, AEMES also is used in virtual events. In a virtual setting, the system manages concurrent content streams, facilitates networking between geographically dispersed attendees, and incorporate AI-powered virtual assistants to enhance the attendee experience.

In summary, the described adaptive event management and engagement system described herein offers a more comprehensive solution to the challenges of organizing and optimizing dynamic events. By leveraging personalization, real-time tracking, and innovative compensation models, the system aims to enhance the experience for attendees while providing fair and accurate compensation for vendors, among other features. The system's adaptability and learning capabilities position it to address the evolving needs of event organizers, attendees, and vendors across a wide range of event types and scales.

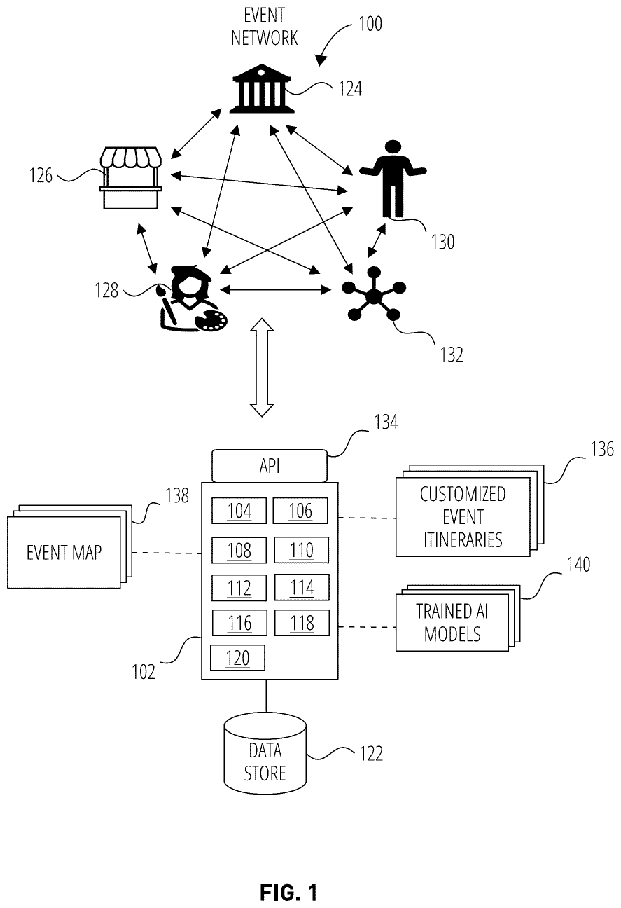

FIG. 1 illustrates an example event ecosystem 100 and an adaptive event management and engagement system (AEMES) 102, according to some examples. In the depicted example, the AEMES 102 includes an adaptive artificial intelligence (AI) system adaptive AI system 104, a vendor compensation system 106, a wait-times system 108, an attendee tracking system 110, and an inclusivity system 112, an authentication system 114, a user interface (UI) system 116, a ticketing system 118, and a feedback system 120. A data store 122 is also shown, suitable for storing a variety of data. The AEMES 102 can be used by various entities 124, 126, 128, 130, 132 to participate as members of the event ecosystem 100 during an event, such as a fair, a conference, a virtual meet, a concert, and so on. For example, a financial entity 124 (e.g., retail and commercial bank, investment bank, brokerage firm, mortgage company, and so on) can participate by providing financial products and/or services such as payment processing services between the entities 126, 128, 130, 132, as well as providing financial analytics services, helping event organizers and vendors understand spending patterns and optimize pricing strategies for future events. The financial entity 124 also manages loyalty programs by integrating its customer loyalty programs with the event, allowing attendees to earn or redeem points for event participation or purchases. The financial entity 124 also assists in implementing income-based pricing features, potentially using its customer data to verify income levels and adjust event costs accordingly. In some examples, the financial entity 124 provides for virtual currency specific to the event, facilitating transactions during the event as well as in the virtual spaces.

Other event entities include vendor entities 126. The vendor entities 126 sell a variety of goods during an event, including online goods, manage physical vendor location(s), and so on, and can include a variety of businesses, such as small, medium, and large business entities. The vendor entities 126 also include entities that produce goods for sale, such as farming entities, restaurants, and the like. Service provider entities 128 provide a variety of services, such as such as entertainers, artists, gig economy services (e.g., drivers, short-term rental providers, long-term rental providers, and the like), consulting services, contractor services, plumbing services, electrician services, software services, legal services, medical and health service providers, and so on, used during the event.

Attendee entities 130 include the entities who are attending the event, such as the general public, guests, and so on. In some examples, an entity such as a vendor entity 126 is also an attendee entity 130. That is, in addition to providing goods for sale, certain vendors will also attend the event and participate like other attendee entities 130. Indeed, the entities 126, 128, and 130 each can have multiple roles as vendors, suppliers, and/or attendees. Also shown are social networks 132. In some examples, entities in a social network 132 includes more loosely organized groups of entities, such as friends, influencers, followers, and so on. The event can also participate in the social networks 132 by advertising, selling tickets, publishing event schedules, and so on.

Entities 124, 126, 128, 130, 132 can interact with the AEMES 102, for example, via an application programming interface (API) 134. In certain embodiments, the API 134 is accessed via API keys (e.g., public/private keys) used to provide authentication and security. The API 134 exposes a set of objects (e.g., classes, functions, callable code) to interface with and use the AEMES 102, including the adaptive AI system 104, the vendor compensation system 106, the wait-times system 108, the attendee tracking system 110, the inclusivity system 112, the UI system 116, the ticketing system 118, and/or the feedback system 120. It is to be noted that the AEMES 102 and the API 134 can be provided by an entity, such as the financial entity 124, by a third-party (e.g., a party not a member of the event ecosystem 100 such as a software-as-a-service (SaaS) cloud provider), or a combination thereof.

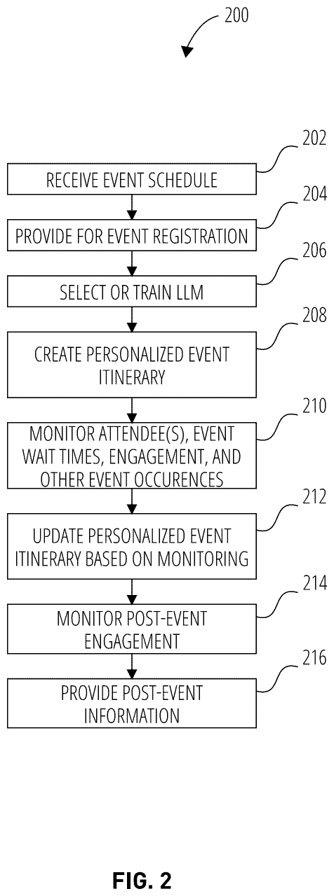

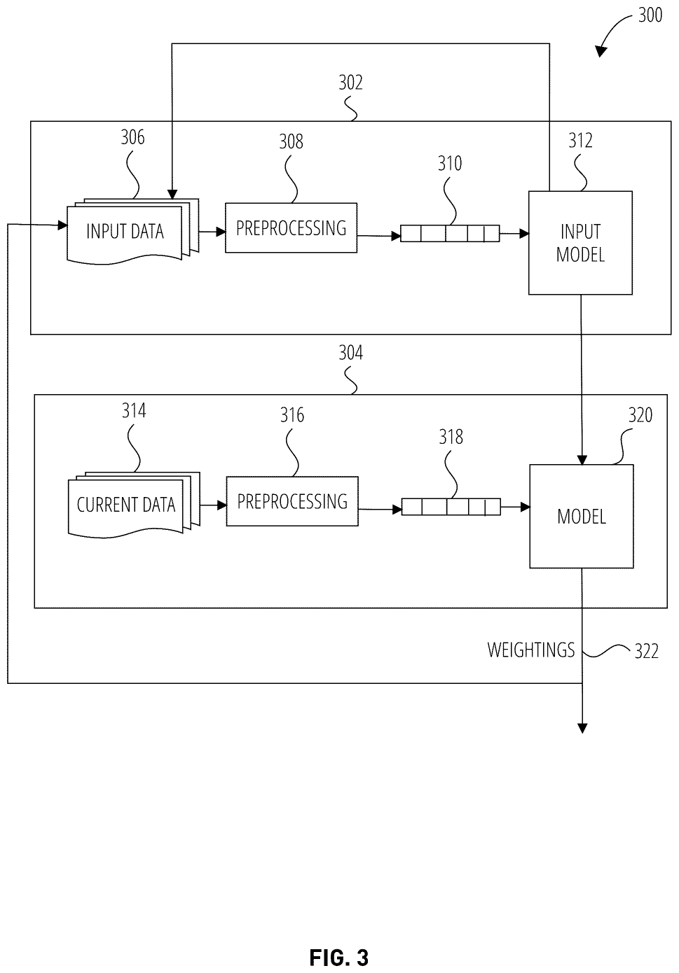

In some examples, the adaptive AI system 104 includes one or more trained AI models 140 that are used for analyzing attendee preferences and creating personalized event itineraries. The adaptive AI system 104 includes, for example, neural network-based AI systems such as predictive neural networks, state vector machines (SVMs), machine learning neural networks, and so on. In some examples, the adaptive AI system 104 includes LLMs, such as transformer-based LLMs. The adaptive AI system 104 utilizes natural language processing techniques, such as large language model techniques, to interpret user inputs and generate customized recommendations. More specifically, the adaptive AI system 104 processes information provided by attendee entities 130 about their interests and preferences for the event to then create personalized and dynamic custom event itineraries tailored to each attendee's interests. The information provided by the attendee entities 130 used to train the adaptive AI system 104 is further described below with respect to FIGS. 2 and 3. An attendee's custom event itinerary 136 is generated as output, that suggests specific vendors and more optimal routes, such that the adaptive AI system 104 recommends particular vendors that align with the attendee's preferences and calculates a more efficient path through the event space.

In some examples, where the adaptive AI system 104 uses LLMs, the LLMs can use retrieval augmented generation (RAG) and similar techniques to determine the more efficient path through the event. In one example, the adaptive AI system 104 first determines, via the trained AI models 140, a list of vendors, activities, presentations, and so on, to attend that is ordered by based on a highest to a lowest interest value, assigning each vendor, activity, presentation, and the like, a cost. The cost is lower if the interest of the attendee is higher. The adaptive AI system 104 then uses traveling salesman problem algorithms that incorporate cost in addition to distance, such as traveling purchaser problem algorithms, e.g., dynamic programming algorithms, Glover's tabu algorithms, vehicle routing problem algorithms, and so on, to determine the suggested route through the event for each individual attendee. In certain examples, the event's geographic map 138, when the event is not a virtual event, is transformed into a distance-based event graph with nodes representing each vendor, activity, presentation, and the like, and edges representing location and distance between nodes. The resulting event graph is then provided to the algorithms that are used to solve the traveling purchaser problem, and the resulting output are provided as the customized event itineraries 136.

In some examples, attendee entities 130 would prefer to attend as a group, such as a family, a couple, a group of friends, a group of colleagues, and so on. Accordingly, the adaptive AI system 104 performs a collective preference analysis where the preferences of all group members are analyzed to identify common interests, but also individual preferences will be accounted for. In some examples, the collective preference analysis uses certain algorithms, such as algorithms that solve for the best-of-n problem, to find optimal compromises when group members have conflicting interests, including the suggestion to split activities for certain time slots. For example, the adaptive AI system 104 will come up with a ranked list of vendors, activities, presentations, and so on, for each attendee in the group, that is ordered by based on a highest to a lowest interest value. The ordered lists are then merged into a single ordered list, for example, based on algorithms that solve the best-of-n-problem, such as symmetric and/or asymmetric robot swam algorithms, including Valenti and Ferrante's symmetric and asymmetric problem formalization/solution algorithms. In Valenti and Ferrante's framework, ρᵢ is defined as the opinion quality associated with each option i∈{1, . . . , n}, and option cost σᵢ>0 associated with each option i∈{1, . . . , n} is defined as the cost. The techniques described herein use opinion quality to be the interest value for an option (e.g., interest value for vendor A), and the option cost as the geographical distance to the option (e.g., distance to vendor A from the current location).

As a single attendee or a group of attendees participates in the event, the AEMES 102 continuously tracks their location via the attendee tracking system 110 and adjusts the customized event itineraries 136 in real-time based on behavior and feedback. For example, the AEMES 102 will alert when an attraction A is set to begin (e.g., musician A is about to perform) but if the attendee(s) choose to ignore the alert and instead remain at the current location (e.g., watching a performance by musician B) until after attraction A is over, the AEMES 102 will then dynamically redirect the attendee(s) to another attraction or vendor. For times when attending members of a group separate, the AEMES 102 suggests more optimal meetup points and times based on individual activities and Event map 138.

In certain examples, the AEMES 102 dynamically adjusts the customized event itineraries 136 by updating the aforementioned event graph. As mentioned above, the event graph is used, having vertices representative of a venue, an attraction, and so on, and edges between vertices representative of distance. The vertices of the event graph that are no longer apply are removed from the event graph, for example, because their respective venue or attraction is now closed, of have been attended by attendee entities 130. The edges in the event graph are also re-adjusted based on current location of the attendee(s). The updated event graph is then used to create updated customized event itineraries 136, for example via the aforementioned traveling purchaser algorithms, best-of-n problem algorithms, and the like.

The vendor compensation system 106 provides for receipt of payments from attendee entities 130 and transfer of the payments to the one or more vendor entities 126. In some examples, the vendor compensation system 106 allocates funds to vendors based on attendee engagement. For example, attendee entities 130 pay a predetermined fixed cost for attending the event as part of the event ticket and/or registration. The vendor compensation system 106 monitor attendee interactions with vendors. This may include:
Time spent at each vendor's location
Purchases made
Interactions with vendor displays or personnel

In some examples, the vendor compensation system 106 then implements a pro rata model, allocating the initial payment to vendors in proportion to the time attendees spend at each establishment once the event is over. The compensation is then based on real-time engagement rather than pre-set allocations. If wait times at a vendor entity 126 exceed a certain threshold, the vendor compensation system 106 may award credits to attendees or provide options to transfer value, or may adjust vendor compensation.

The vendor compensation system 106 also tracks referrals between vendors. For example, if Vendor A refers an attendee entity 130 to Vendor B, this interaction is factored into the compensation calculations. The vendor compensation system 106 also continues to track engagement for a period after the event has concluded. For instance, if an attendee entity 130 later visits a vendor's website or makes additional purchases, these actions are then provided to the vendor entity 126 for them to factor sales due to the event.

The wait-times system 108 continuously monitors queue lengths and durations at vendor locations. In some examples, a predetermined threshold is established for acceptable wait times at each vendor or attraction. When the wait-times system 108 detects that wait times have exceeded the set threshold, the wait-times system 108 can award credits or give attendee entities 130 the option to transfer value. This could be in the form of digital tokens, discounts for future purchases, or additional time added at certain attractions. The wait-times system 108 additionally or alternatively suggests alternative vendors or attractions to attendees, helping to redistribute crowds and reduce congestion. The wait-times system 108 also notifies vendors of excessive wait times, allowing them to take action to improve efficiency or capacity. Wait time data is stored in the data store 122, allowing for an analysis of crowd flow patterns and vendor popularity. When used over time (e.g., over multiple events), the wait-times system 108 uses historical wait time data to develop predictive models, anticipating potential congestion points and suggesting proactive measures.

The attendee tracking system 110 provides for location tracking on attendees'smartphones, smart watches, event-provided RFID wristbands, and so on, to monitor their movement through the event map 138. This monitoring provides real-time data on attendee positions and flow patterns used by various subsystems of the AEMES 102, such as the adaptive AI system 104, the vendor compensation system 106, and the wait-times system 108. For attendee entities 130 registered as part of a group, the attendee tracking system 110 can track collective behavior and preferences, helping other subsystems to inform group itinerary suggestions and meetup points. In cases of virtual or hybrid events, the attendee tracking system 110 can monitor online engagement, such as participation in virtual sessions, interactions with other digital content, virtual meets with other attendee entities 130, breaks taken by an attendee entity 130, and so on.

The inclusivity system 112 aims to create a more welcoming and accessible event environment for all attendee entities 130, regardless of their background, abilities, or specific needs. By considering various aspects of diversity and inclusion, the inclusivity system 112 enhances the overall event experience and ensures that a wider range of individuals can fully participate and enjoy the offerings. In certain examples, the inclusivity system 112 supports income-based pricing that considers the income levels of attendees when determining their payments, including ticket prices, event registration, and/or attending certain activities. Entities 124, 126, 128 can also participate with adjustable pricing for products and services provided. This feature allows for more equitable access to events by adjusting costs based on an individual's financial situation.

The inclusivity system 112 additionally takes into account neurodiversity when determining pricing and event experiences. For example, people with autism can be provided special pricing and funds allocated to create areas and attractions to better entertain with more sensory-friendly environments. This consideration ensures that individuals with diverse neurological conditions can participate more comfortably in events. When the inclusivity system 112 is in use, the customized event itineraries 136 can take into account specific needs or preferences related to inclusivity. For example, the inclusivity system 112 might suggest quieter areas for individuals with sensory sensitivities or ensure accessible routes for those with mobility challenges based on purchasing certain tickets (e.g., sensory sensitive ticket, mobility accessible ticket).

The AEMES 102 additionally offers customizable graphical user interfaces (GUIs) for interacting with the event attendance tools, event management tools, and the like, to accommodate various visual, auditory, cognitive, and multi-language needs. In some examples, the GUIs are provided via the UI system 116. Accessibility information is also provided by the AEMES 102, describing accessibility information for each vendor or attraction before and during the event, thus helping attendees with specific needs plan their event experience more effectively. For attendee entities 130 who require additional assistance, the AEMES 102 offers options for registering companions or caregivers at reduced rates and/or with special access privileges. For events involving food, the inclusivity system 112 can track and highlight vendors offering diverse dietary options, including allergen-free, kosher, halal, vegan, and other specialized diets.

In some examples, the ticketing system 118 utilizes QR codes or digital tokens for attendee registration and event access. A digital wallet is also provided. Each ticket is associated by the ticketing system 118 with a digital wallet that tracks the attendee's consumable budget, purchases, and earned rewards throughout the event. Post-event, tickets continue to provide value, granting access to online content, vendor websites, or future promotions related to the event experience. For hybrid or fully virtual events, the ticketing system 118 can issue digital-only passes that grant access to online platforms and virtual experiences.

The authentication system 114 authenticates users of the AEMES 102, for example, via multi-factor authentication. A user of the AEMES 102 enters a user/password combination, and the authentication system 114 will verify the combination and transmit a code to the user to further authenticate a login into the AEMES 102. Communications of the AEMES 102 are encrypted, for example using Transport Layer Security (TLS), to prevent eavesdropping and man-in-the-middle attacks. The authentication system 114 also provides for password policies suitable for using complex passwords and regular changes to reduce the risk of compromise.

The UI system 116 provides for a graphical user interface that includes windows, icons, menus, buttons, and all the other elements that are manipulated by the user with a pointing device like a mouse or touchpad. Command-Line Interfaces (CLIs) are also provided via the UI system 116. The CLIs allow users to interact with the AEMES 102 by typing commands into a terminal or command prompt. The UI system 116 also provides for touch interfaces designed for touch screens. These touch interfaces allow users to interact with the AEMES 102 through touch gestures such as tapping, swiping, and pinching. Voice User Interfaces (VUIs) are also included in the UI system 116. The VUIs enable interaction with the AEMES 102 through voice or speech commands.

The data store 122 is a database, such as a relational database, an object-oriented database, a cloud-based database, and the like, that is operatively coupled to the AEMES 102. The data store 122 stores information such as the trained AI models 140, the customized event itineraries 136, the Event map 138, social media information, mentoring information, and so on. In some examples, the data store 122 is encrypted and the data anonymized to increase security of the AEMES 102.

The feedback system 120 can collect feedback from attendees throughout the event as well as after the event. The feedback collected includes reviews of the various entities 124, 128, 130 participating in the event. After the event concludes, attendees may be prompted to complete surveys about their experience. These surveys can gather detailed information on specific aspects of the event, vendor interactions, and overall satisfaction. The feedback system 120 analyzes vendor performance based on attendee engagement, wait times, and sales data. This information is used to evaluate vendor effectiveness and inform future event planning. The feedback system 120 additionally assesses the effectiveness of personalized itineraries by comparing planned routes with actual attendee behavior. This analysis helps refine the itinerary creation algorithms for future events. This feedback is useful in continuing to evolve and improve the event and those like it, providing increasingly personalized and effective event experiences for attendees while improving operations for event organizers and vendors.

FIG. 2 is a flowchart of a process 200 for providing dynamic customized event itineraries, according to some examples. In the depicted example, the process 200, at block 202, receives an event schedule. The event schedule includes a list of event activities, such as musical groups, performing artists, presentations, and so on, their respective times, and locations. In some examples, the event map 138 is also received at block 202. The event schedule additionally includes a list of participating vendor entities 126 and service provider entities 128. The locations for each vendor entity 126 and service provider entity 128 is also provided as part of the event schedule.

The process 200 the, at block 204, provides for event registration and/or ticket sales. For example, the UI system 116 includes online GUIs used to offer registration services that enable an attendee entity 130 to register for the event. Some events include a prepayment, such as the sale of entry tickets, activity tickets, and/or registration. The process 200 can use income-based pricing that considers the income levels of attendees when determining their payments, including ticket prices, event registration, and/or attending certain activities. For example, certain attendee neurodiversity and/or an attendee handicap condition is eligible for receiving discounts during the event registration as well as during certain participating vendors and/or activities in the event.

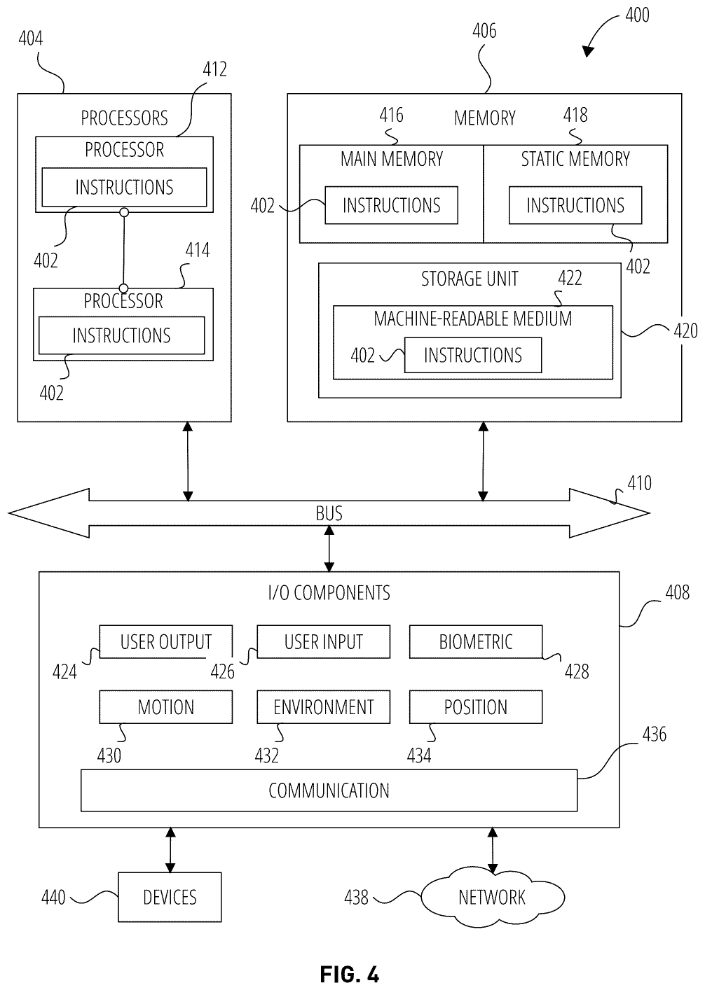

The process 200 then, at block 206, selects one or more of the trained AI models 140 and/or trains one or more AI models to create the trained AI models 140. As mentioned earlier, the trained AI models 140 include trained LLMs. In one example, the trained AI models 140 (e.g., trained LLMs) are provided already trained by the model manufacturer. The training typically includes using a large corpus of subject matter material, including general knowledge such as history, geography, science, literature, arts, and popular culture; technology such as computer science, software development, artificial intelligence, machine learning, and emerging technologies; and business and finance such as economics, marketing, management, entrepreneurship, accounting, and financial markets, among other subject matter material. In some examples, the trained LLMs are “homegrown” LLMs that have been trained internally, for example, using open source training data sets such as C4, common crawl, and/or Wikipedia. Further description on training and tuning of the trained AI models 140 is provided with respect to FIG. 4.

In some examples, the trained AI models 140 (e.g., trained LLMs), additionally use training data such as social media posts for attendee entities 130 that will be attending the event. In these examples, certain attendee entities 130 give permission to the event administrators or managers to have the LLMs further trained or “tuned” to derive activities that the attendees like and/or activities that the attendee dislike. Likewise, the social posts are used to further tune the LLMs to derive products and services that the attendees like and/or products and services that the attendees dislike. In certain examples, surveys are used. That is, surveys are sent to event attendees with lists of activities, products, services, and so on, and the training data set then incorporates survey responses listing activities that the attendees like, activities that the attendee dislike, products and services that the attendees like, and/or products and services that the attendee dislike. The surveys also include likes and dislike associated with neurodiversity and/or certain handicap conditions, such as level of noise, crowd levels, use of ramps, use of elevators, distances to be traveled during the event, and so on. Surveys, as well as training social posts, can used by the trained AI models 140 to derive a metric of “likes” and “dislikes”, such as between 0 to 10 where 10 is a very high measure of like or dislike. In some examples, the survey responses are used via retrieval augmented generation (RAG) techniques to derive each individual attendee's “likes” and “dislikes.”

The process 200 then, at block 208, creates the personalized or customized event itineraries 136. In some examples, the trained AI models 140 are used to create the personalized event itineraries 136. For example, the trained LLMs are prompted, via language prompts, to create an itinerary. That is, the trained LLM receive as an input prompt the event schedule and the list of attendees and then are also prompted, as part of the input prompt, to create the personalized event itinerary as output. A non-limiting example prompt is “For the event schedule S.doc that is included in this prompt and the list of attendees A.doc that is also included in this prompt, create a personalized event itinerary for each attendee that is ordered by activity and by vendor taking in consideration the attendee's likes and dislikes, ability to travel inside the event area (use event Map.pdf and/or event_graph.G), and the start/end times for each activity.” Similarly prompting is used for groups of attendee entities 130, such as “For the event schedule S.doc that is included in this prompt and the list of groups of attendees and their respective members found in group_of_attendees A.doc that is also included in this prompt, create a personalized event itinerary for each group of attendees that is ordered by activity and by vendor taking in consideration the attendee's likes and dislikes, ability to travel inside the event area (use event Map.pdf and/or event_graph.G), and the start/end times for each activity.”. The trained LLMs will then produce as output a subset of the list of event activities merged with a subset of the list of vendors that is ordered by suggested attendance order and/or suggested route to take, e.g., “First go visit hat vendor X, then proceed via blue route to participate in Activity Y, then stop for a snack at food vendor booth Z . . . ”

During the event, the process 200 then monitors various event occurrences as well as attendees at block 210. For example, attendee entity 130 location can be monitored via cell phone, smart watch, RFID bracelet, and so on. Likewise, wait times at various activities, vendor booths, and other areas (e.g., restrooms, break areas, exits, parking locations) are monitored via cameras, via event drones, via cell phones carried by attendee entity 130 that are waiting in line, and so on. Similarly, noise levels through the event and crowd densities at various event locations (e.g., activities, vendors, quiet areas, restrooms, parking locations) are monitored. The noise level monitoring, in some examples, is done via noise level sensors and/or microphones dispersed through the event.

The process 200 additionally monitors activity and/or vendor engagement at block 210. For example, the process 200 uses attendee entity 130 location information to determine how many times and for how long certain activities are engaged with, such as an art installation, a quiet area, a music performance, a park ride, a face painting activity, and so on. Likewise, how many times an attendee entity 130 visits a vendor entity 126 is captured, regardless of whether or not a product or a service was purchased. Purchases of goods and services provided by the vendor entities 126 and purchased during the event are also tracked. Engagement metrics that are derived by the process 200 include an average time spent by attendees to the event at a location of the activity or vendor, a median time spent by the attendees at the location of the activity or vendor, and/or a review metric for the activity and/or vendor received during the event. Indeed, attendee entities 130 can also review various activities and/or vendors during the event to inform others. In summary, tracking the vendor engagement for the attendee entities 130 includes monitoring, via the one or more sensors, movement of the plurality of attendees through the event space, calculating a time spent by the attendee entities 130 at each vendor's location (e.g., booth or, tracking purchases made by the plurality of attendees from each vendor, logging interactions between the plurality of attendees and vendor displays or personnel, or a combination thereof. An engagement metric for each vendor can then be calculated based on the monitoring, the time spent, the tracked purchases, and/or the logged interactions. These engagement metrics will then be used to divide all vendor payments received among all the vendors. For example, each vendor will initially start with an amount equal to the amount of payments they would have received normally, and the engagement metric will then raise of lower this amount so that all vendors then share the total vendor payments with engagement metrics included.

The process 200 then, at block 212, updates one or more of the personalized event itineraries 136 based on the monitoring of block 210. For example, wait times are taken into account, as well as a current attendee entity 130 location, to update the personalized event itinerary 136 of an attendee or group of attendees. For example, if a wait time exceeds a value set by an attendee or group of attendees, the process 200 automatically will re-prompt the trained LLM to update their personalized event itinerary 136 by removing the activity and/or vendor currently being waited on. The updated personalized itineraries 136 can also be updated based on exceeding certain attendee-specified noise levels, crowd densities, cancelation or “no show” of activities or vendors, and so on.

In some examples, the process 200 will update the previously used prompt files and prompt, such as “For the event schedule S_update.doc that is included in this prompt and the list of attendees A.doc that is also included in this prompt, create a personalized event itinerary for attendee X that is ordered by activity and by vendor taking in consideration the attendee's likes and dislikes, ability to travel inside the event area (use event Map.pdf and/or updated_event_graph.G), the start/end times for each activity, and the current location of Attendee X.” An attendee can also request an updated personalized event itinerary 136 at any time, for example, via the UI system 116. Indeed, attendee entities 130 can “chat” with the trained LLM to ask questions about wait time, reviews for activities/vendors, suggestions on food snacks, location of friends, suggestions for other products/services that the vendors only provide online, and so on. Thus, enhancing event attendance via LLM technology.

The process 200 additionally monitors, at block 214, post-event engagement. For example, attendee entities 130 can log into online systems after the event to purchase goods and/or services, such as music, clothing, art, dining services, and so on. In some examples, monitoring is done via an event code that will provide discounts on online purchases, via event referral online links, via internet cookies and/or tracking pixels, via Urchin Tracking Module (UTM), and so on. The tracking can take place for a period of time after the event, such as one week, two weeks, one month, one year. The tracking of event-related purchases is then provided to vendors via an online sales report. Accordingly, vendors can track how the event has affected sales over a certain time period. The process 200, at block 216, additionally provides post-event information. In addition to the aforementioned online sales report, the process 200 can provide reports for attendance, reports for engagement metrics, reports that include activity/vendor reviews, reports that include times and locations of overly long wait times, high crowd densities, overly loud noises, and so on, to improve future events. By providing for after-event feedback, the techniques described herein improve future event planning and execution, as well as increasing future attendee engagement and enjoyment.

FIG. 3 illustrates machine learning engine for training the one more trained AI models 140, including the trained LLMs, in accordance with some examples. The machine learning engine may be deployed to execute at a mobile device (e.g., a cell phone) or a computer. A system, such as the AEMES 102, may calculate one or more weightings for criteria based upon one or more machine learning algorithms.

Machine learning engine 300 uses a training engine 302 and a prediction engine 304. Training engine 302 uses 306, for example after undergoing preprocessing component 308, to determine one or more features 310. The one or more features 310 may be used to generate an initial model 312, which may be updated iteratively or with future labeled or unlabeled data (e.g., during reinforcement learning).

The input data 306 may include a large corpus of subject matter material, including general knowledge such as history, geography, science, literature, arts, and popular culture; technology such as computer science, software development, artificial intelligence, machine learning, and emerging technologies; and business and finance such as economics, marketing, management, entrepreneurship, accounting, and financial markets, among other subject matter material. In some examples, the input data 306 using open source training data sets such as C4, common crawl, and/or Wikipedia. Additionally, the training data may include as social media posts for attendee entities 130 that will be attending the event. In these examples, certain attendee entities 130 give permission to the event administrators or managers to browse their social posts online. The social posts include certain activities, products, and/or services, along with text that is representative of likes or dislikes (e.g. “I'm enjoying eating chocolate ice cream, “I just bought a new hat,” “My new long-sleeved shirt is too uncomfortable”, and so on). In certain examples, surveys are used. That is, surveys are sent to event attendees with lists of activities, products, services, and so on, and the training data set then incorporates survey responses listing activities that the attendees like, activities that the attendee dislike, products and services that the attendees like, and/or products and services that the attendee dislike. The surveys also include likes and dislike associated with neurodiversity and/or certain handicap conditions, such as level of noise, crowd levels, use of ramps, use of elevators, distances to be traveled during the event, and so on.

In the prediction engine 304, current data 314 (e.g., event schedule, current location, wait time, noise level, crowd density, and so on) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user. Labels for the input data 306 may include “like” labels, “dislike labels”, “too much waiting” labels, “too loud labels”, “too crowded labels”, “very quiet” labels, and so on.

The initial model 312 may be updated using further input data 306 until a satisfactory model 320 is generated. The model 320 generation may be stopped according to a specified criteria (e.g., after sufficient input data is used, such as 1,000, 10,000, 300,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like. Once trained, the model 320 may output the trained AI models 140.

FIG. 4 is a diagrammatic representation of a machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the processes or methods described herein, such as the process 200. The instructions 402 transform the general, non-programmed machine 400 into a particular machine 400, e.g., the AEMES 102, programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 416, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 434 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 1200 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a universal serial bus (USB) port), internet-of-things (IoT) devices, and the like.

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

The techniques described herein provide for the automatic derivation and use of community-based credit scores.

1. A system for adaptive event management, comprising:
a memory storing instructions; and
one or more hardware processors configured to execute the instructions to perform operations to:
receive payments, via a payment system, from a plurality of attendees of an event;
calculate an engagement metric, via one or more sensors, of the plurality of attendees with a plurality of vendors during the event, wherein the engagement metric comprises time spent by attendees at each vendor's location of the plurality of vendors and wherein calculating the engagement metric comprises:
monitoring, via the one or more sensors, movement of the plurality of attendees through an event space of the event in real-time to derive a real-time sensor data; and
calculating an attendee time spent by each attendee of the plurality of attendees at each vendor's location based on the real-time sensor data, wherein the one or more sensors comprise a location tracking sensor disposed on a mobile device carried by each attendee;
allocate the payments, or a portion thereof, via the payment system, to the plurality of vendors in proportion to the tracked engagement metric of the plurality of attendees with each vendor of the plurality of vendors by:
calculating a respective credit allocation amount for each vendor based on their tracked engagement metric;
initiating an electronic fund transfer to one or more vendor accounts based on the respective credit allocation amount for each vendor;
generating an online payment report comprising payment attributable to the engagement metric during the event and time spent by attendees at each vendor's location; and
create a personalized event itinerary for an attendee of the plurality of attendees via a trained artificial intelligence (AI) model that processes the real-time sensor data to dynamically adjust the personalized event itinerary based on current wait times, crowd density, attendee location, or a combination thereof; and
present the adjusted personalized event itinerary on a display of the mobile device.

2. The system of claim 1, wherein tracking the engagement of the plurality of attendees further comprises monitoring, via the one or more sensors, movement of the plurality of attendees through an event space, calculating a time spent by the attendees plurality of attendees at each of the vendor's location, tracking purchases made by the plurality of attendees from each vendor, logging interactions between the plurality of attendees and vendor displays or personnel, or a combination thereof.

3. (canceled)

4. The system of claim 1, wherein the operations further comprise:
tracking online purchases made by the attendees of goods and services sold by one or more vendors of the plurality of vendors;
creating an online sales report based on the tracked online purchases; and
providing the online sales report to the one or more vendors.

5. The system of claim 4, wherein tracking online purchases further comprises tracking online purchases for a time period after the event has finished, and providing the online sales report to the one or more vendors.

6. (canceled)

7. The system of claim 1, wherein the adjusted personalized event itinerary comprises at least one of a rerouted path to a second activity in a list of activities, a suggestion for an alternative activity not listed in the list of activities, or a revised suggested attendance order for a set of the list of activities.

8. The system of claim 1, wherein the operations further comprise:
creating a second personalized event itinerary for a group of attendees in the plurality of attendees via the trained AI model, wherein the trained AI model is configured to receive as input the adjusted personalized event itinerary to create the second personalized event itinerary as output, wherein the second personalized event itinerary comprises a set of a list of activities ordered by a suggested attendance order; and
automatically adjusting the second personalized event itinerary via the trained AI model during occurrence of the event, wherein the trained AI model is configured to receive as input the wait time for the activity of the list of activities and a current location for the group of attendees to create the adjusted second personalized event itinerary as output.

9. The system of claim 1, wherein an event schedule comprises a list of vendors and wherein the trained AI model is further configured to create the personalized event itinerary to comprise a set of the list of vendors merged with a set of the list of events ordered by suggested attendance order as output.

10. The system of claim 1, wherein the trained AI model is configured to receive as input a neurodiverse condition, a handicap condition, or a combination thereof, to create the personalized event itinerary as output, based on a set of a list of activities comprising a first activity designed for individuals with sensory sensitivities, a second activity designed for those with mobility challenges, or a combination thereof.

11. The system of claim 1, wherein the operations further comprise training an AI model into the trained AI model by using a training data set, the training data set comprising a plurality of social network posts.

12. The system of claim 11, wherein the plurality of social network posts comprise social network posts representative of activities that an attendee of the plurality of attendees likes, representative of activities that the attendee dislikes, or a combination thereof.

13. The system of claim 11, wherein the plurality of social network posts comprise social network posts representative of products and services that an attendee of the plurality of attendees likes, representative of products and services that the attendee dislikes, or a combination thereof.

14. The system of claim 1, wherein the operations further comprise training an AI model into the trained AI model by using a training data set, the training data set comprising a survey response listing a plurality of activities that an attendee of the plurality of attendees likes, a plurality of activities that the attendee dislikes, a plurality of products and services that the attendee likes, a plurality of products and services that the attendee dislikes, or a combination thereof.

15. The system of claim 1, wherein the trained AI model is further configured to receive as input a crowd density for an activity in a list of event activities to create the adjusted personalized event itinerary as output.

16. The system of claim 1, wherein the trained AI model comprises a trained large language model (LLM).

17. The system of claim 1, wherein the payments comprise ticket sales for the event, registration sales for the event, vendors sales during the event, or a combination thereof.

18. The system of claim 1, wherein the operations further comprise adjusting an event ticket price for the event, an event registration price for the event, or a combination thereof, based on an attendee income level, an attendee neurodiversity, an attendee handicap condition, or a combination thereof.

19. A method, comprising:
receiving payments, via a payment system, from a plurality of attendees of an event;
calculating an engagement metric, via one or more sensors, of the plurality of attendees with a plurality of vendors during the event, wherein the engagement metric comprises time spent by attendees at each vendor's location of the plurality of vendors and wherein calculating the engagement metric comprises:
monitoring, via the one or more sensors, movement of the plurality of attendees through an event space of the event in real-time to derive a real-time sensor data; and
calculating an attendee time spent by each attendee of the plurality of attendees at each vendor's location based on the real-time sensor data, wherein the one or more sensors comprise a location tracking sensor disposed on a mobile device carried by each attendee;
allocating the payments, or a portion thereof, via the payment system, to the plurality of vendors in proportion to the tracked engagement metric of the plurality of attendees with each vendor of the plurality of vendors by:
calculating a respective credit allocation amount for each vendor based on their tracked engagement metric;
initiating an electronic fund transfer to one or more vendor accounts based on the respective credit allocation amount for each vendor; and
generating an online payment report comprising payment attributable to the engagement metric during the event and time spent by attendees at each vendor's location;
creating a personalized event itinerary for an attendee of the plurality of attendees via a trained artificial intelligence (AI) model that processes the real-time sensor data to dynamically adjust the personalized event itinerary based on current wait times, crowd density, attendee location, or a combination thereof; and
presenting the adjusted personalized event itinerary on a display of the mobile device.

20. A non-transitory computer-readable medium storing instructions that, when executed by one or more hardware processors of a computer system, cause the computer system to perform operations comprising:
receiving payments, via a payment system, from a plurality of attendees of an event;
calculating an engagement metric, via one or more sensors, of the plurality of attendees with a plurality of vendors during the event, wherein the engagement metric comprises time spent by attendees at each vendor's location of the plurality of vendors and wherein calculating the engagement metric comprises:
monitoring, via the one or more sensors, movement of the plurality of attendees through an event space of the event in real-time to derive a real-time sensor data; and
calculating an attendee time spent by each attendee of the plurality of attendees at each vendor's location based on the real-time sensor data, wherein the one or more sensors comprise a location tracking sensor disposed on a mobile device carried by each attendee;
allocating the payments, or a portion thereof, via the payment system, to the plurality of vendors in proportion to the tracked engagement metric of the plurality of attendees with each vendor of the plurality of vendors by:
calculating a respective credit allocation amount for each vendor based on their tracked engagement metric;
initiating an electronic fund transfer to one or more vendor accounts based on the respective credit allocation amount for each vendor; and
generating an online payment report comprising payment attributable to the engagement metric during the event and time spent by attendees at each vendor's location;
creating a personalized event itinerary for an attendee of the plurality of attendees via a trained artificial intelligence (AI) model that processes the real-time sensor data to dynamically adjust the personalized event itinerary based on current wait times, crowd density, attendee location, or a combination thereof; and
presenting the adjusted personalized event itinerary on a display of the mobile device.
